(19) United States
(12) Patent Application Publication
(10) Pub. No.: US 2009/0244627 A1
(43) Pub. Date: Oct. 1, 2009

(54) Chromatics-based reading and writing system and method thereof

(76) Inventors: Mang Ou-Yang, Jhongli City (TW); Liu-Kung Lin, Jhongli City (TW); Kuo-Ting Ho, Jhongli City (TW); Jia-Hao Li, Jhongli City (TW); Ting-Wei Huang, Jhongli City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/078,355

(22) Filed: Mar. 31, 2008

(51) Int. Cl. G06F 15/00

(52) U.S. Cl. 358/2.1; 358/1.9

(57) ABSTRACT

The present invention discloses a chromatics-based reading/writing system and method. In the present invention, the chromatics-based reading/writing system comprises: a color dot reading/writing device; a color dot recording medium recording data in the color-dot form; and a computer system coupled to the color dot reading/writing device, coding data into setting values of color dots, controlling the color dot reading/writing device to write data on the color dot recording medium in the form of color dots according to the setting values of color dots, controlling the color dot reading/writing device to read color dots on the color dot recording medium, and decoding the setting values of the color dots into the original data.

### BACKGROUND OF THE INVENTION

1. Field of the Invention

The present invention relates to a chromatics-based storage/retrieve technology, particularly to a chromatics-based reading/writing system and method.

2. Description of the Related Art

The optical disc and optical disc drive are typical products in the field of optical information storage. The optical disc is a circular plastic substrate having a diameter of 12 cm and a thickness of 0.12 cm. An information layer, which is a metal film having pits to record data, is on the circular substrate. The metal film is usually made of an aluminum alloy or copper alloy. A protection layer covers the information layer lest the information layer be oxidized or damaged.

The laser reading/writing head emits laser light, which is projected via a lens onto the pit positions and non-pit positions on the information layer. The laser reading/writing head converts the reflected light into binary coded data. Then, the microprocessor converts the binary coded data into related information or audio signals.

From the above discussion, it is known: The denser the pits, the higher the storage capacity of a unit area of an optical disc. The current single-side single-layer DVD optical disc has a capacity of 4.7 GB, and it means that a byte occupies an area of 2.406e−12 m². The current single-side dual-layer DVD optical disc has a capacity of as high as 8.5 GB.

At present, the manufacturers are still endeavoring to persistently promote the storage capacity of a single optical disc with an identical area, but the effect of increasing the storage capacity is not very good with the conventional approaches in increasing the density of pits. Nevertheless, the present invention intends to break through the conventional technologies and provide a novel and distinct storage/retrieve technology.

### SUMMARY OF THE INVENTION

The primary objective of the present invention is to provide a chromatics-based reading/writing system and method to break through the conventional technologies, wherein the computer system codes data into the setting values of color dots firstly; next, according to the setting values of color dots, a color dot reading/writing device writes the data on a color dot recording medium in the form of color dots; thus, the color dot recording medium bears the data; the color dot reading/writing device reads the color dots on the color dot recording medium and converts the color dots into the setting values of the color dots; then the computer system decodes the setting values of the color dots into the original data.

To achieve the abovementioned objective, the present invention proposes a chromatics-based reading/writing system, which comprises: a color dot reading/writing device; a color dot recording medium recording data in the color-dot form; and a computer system coupled to the color dot reading/writing device. In the present invention, the computer system codes data into the setting values of color dots, i.e. the RGB setting values of color dots. According to the RGB setting values of color dots, the color dot reading/writing device writes the data on the color dot recording medium in the color-dot form. Based on the principles of chromatics, the color dot reading/writing device reads the color dots on the color dot recording medium and converts the color dots into the RGB setting values thereof. Then, the computer system further decodes the RGB setting values of the color dots into the original data.

The present invention also proposes a chromatics-based reading/writing method, which comprises: coding data into the setting values of color dots; writing the data on a color dot recording medium in the color-dot form according to the setting values of color dots; using a transform matrix to transform the tristimulus values (X, Y, Z) of the CIE YXZ system into the setting values of color dots; and decoding the setting values of color dots, wherein the way of writing may be a printing process implemented by an ink-jet printer or a laser printer.

Suppose that writing is implemented by an ink-jet printer. The diameter of a dot formed by an ink-jet printer is about 0.6-1 μm. If the color dot recording medium is a circular disc having a diameter equal to that of a traditional optical disc, i.e. 12 cm, the present invention can achieve a storage capacity of as high as 11.310-31.416 GB. Therefore, the present invention can greatly increase the storage capacity.

Based on the specification of the present invention, the persons skilled in the art can easily make a modification or variation without departing from the spirit of the present invention, Therefore, it is to be noted herein: Any equivalent modification or variation according to the spirit of the present invention is to be also included within the scope of the present invention.

Below, the embodiments of the present invention will be described in detail to further demonstrate the present invention. However, the embodiments are only to exemplify the present invention but not to limit the scope of the present invention.

### BRIEF DESCRIPTION OF THE DRAWINGS

FIG. 1 is a diagram schematically showing a chromatics-based reading/writing system according to the present invention; and

FIG. 2 is a flowchart for a chromatics-based reading/writing method according to the present invention.

### DETAILED DESCRIPTION OF THE INVENTION

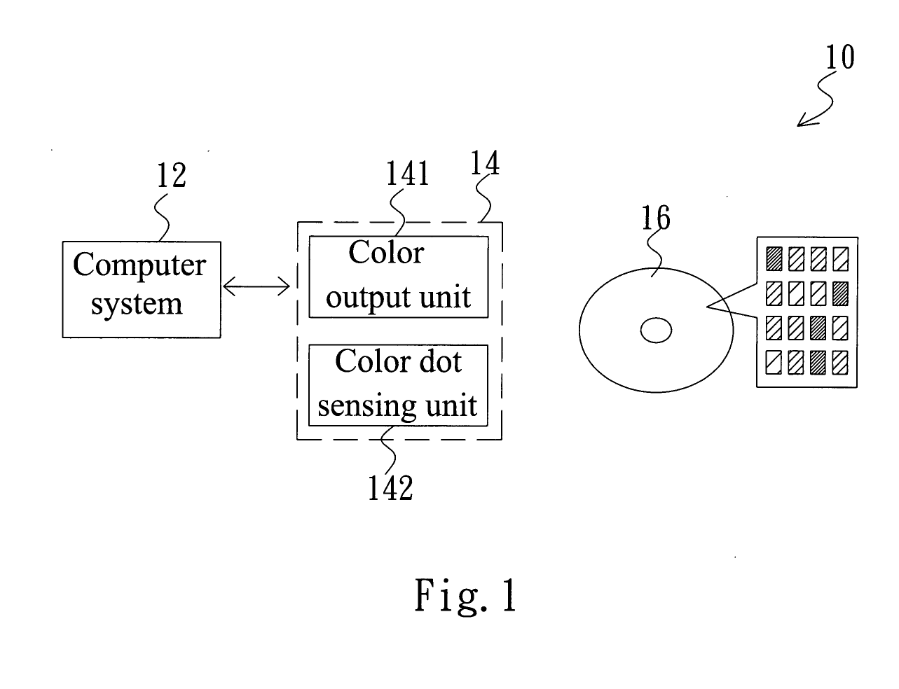

Refer to FIG. 1a diagram schematically showing a chromatics-based reading/writing system according to the present invention. In the present invention, the chromatics-based reading/writing system 10 comprises: a computer system 12; a color dot reading/writing device 14 coupled to the computer system 12; and a color dot recording medium 16 recording data in the form of color dots, wherein the color dot reading/writing device 14 further comprises: a color output unit 141 and a color dot sensing unit 142. The color output unit 141 may be a color printer, such as an ink-jet printer or a laser printer.

Below is described the process that the system of the present invention writes data on the color dot recording medium 14. Based on the principles of chromatics, the computer system 12 codes data into the setting values of color dots, i.e. the RGB setting values of color dots, wherein each bit of the RGB setting value of a color dot ranges from 0 to 255. Next, according to the RGB setting values of color dots, the color output unit 141 of the color dot reading/writing device 14 records the data on the color dot recording medium 16 in the color-dot form. Thus, the data is stored in the color dot recording medium 16. As each bit of the RGB setting value of a color dot ranges from 0 to 255, a dot has 256³ types of permutations. In other words, an RGB dot may have as many as 256³ possible types of information. Suppose that the color output unit 141 is an ink-jet printer. The diameter of a dot formed by an ink-jet printer is about 0.6-1 μm. If the color dot recording medium 16 is a circular disc having a diameter equal to that of a traditional optical disc, i.e. 12 cm, the present invention can achieve a storage capacity of as high as 11.310-31.416 GB. Therefore, the present invention can greatly increase the storage capacity. In the traditional storage media, a byte has 8 bits, and a byte can only have 2⁸=256 possible types of information. The present invention makes one byte able to carry the possible arrangements equal to the total number of colors that an ink-jet printer can present. Ideally, the total number of colors is 256³=16777216. In other words, one byte may have 16777216 possible types of information in the present invention.

When the computer system 12 wants to read the data stored in the color dot recording medium 16, the color dot sensing unit 142 detects the color dots on the color dot recording medium 16, wherein the color dot sensing unit 142 may be a spectrometer. Then, based on the principles of chromatics, the color dot sensing unit 142 calculates the CIE XYZ tristimulus values (X, Y, Z) of the color dots and uses a transform matrix, such as a high-order transform matrix, to transforms the CIE XYZ tristimulus values (X, Y, Z) into the RGB setting values of the color dots. Then, the computer system 12 receives the RGB setting values of the color dots and decodes the RGB setting values of the color dots into the original data.

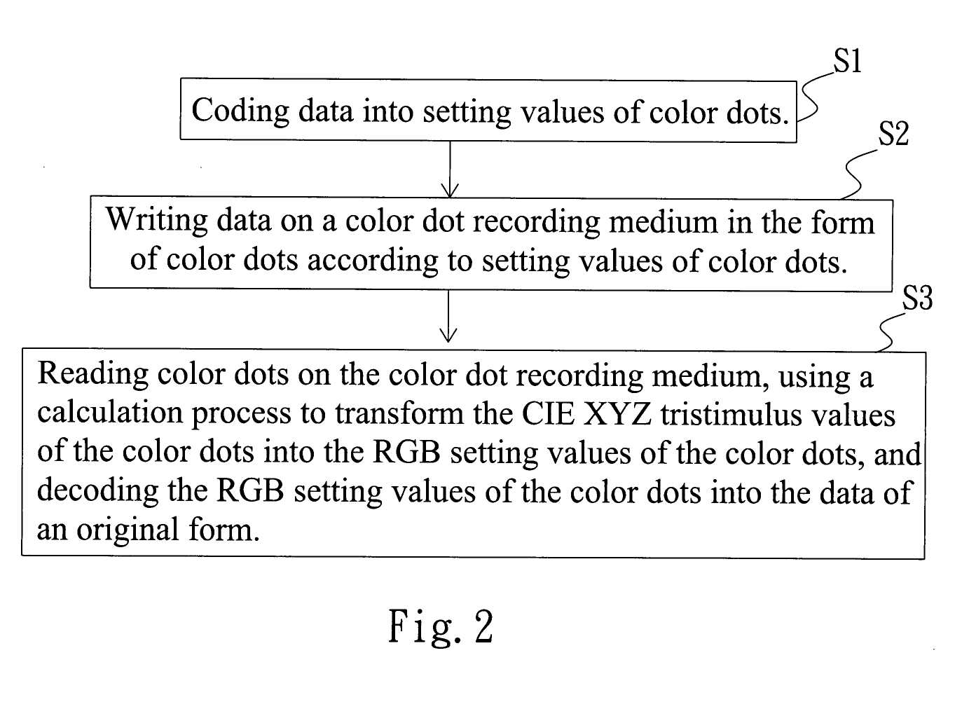

Refer to FIG. 2 a flowchart for a chromatics-based reading/writing method according to the present invention. In Step S1, a computer system applies the principles of chromatics to code data into the RGB setting values of color dots. In Step S2, a color dot writing/reading device writes the data on a color dot recording medium in the form of color dots according to the RGB setting values of the color dots, wherein the writing is a printing process performed by a color output unit of the color dot reading/writing device, such as an ink-jet printer or a laser printer. In Step S3, a color dot sensing unit of the color dot writing/reading device reads the color dots on the color dot recording medium, uses the principles of chromatics to calculate the CIE XYZ tristimulus values (X, Y, Z) of the color dots and uses a high-order transform matrix to transforms the CIE XYZ tristimulus values (X, Y, Z) into the RGB setting values of the color dots. Then, the computer system decodes the RGB setting values of the color dots into the original data.

Below is described the deductive process to obtain the parameters of the high-order transform matrix. Suppose that the original RGB setting values are (α, α, γ), and that the CIE XYZ tristimulus values of the color dots on the color dot recording medium are (X, Y, Z), and that the RGB setting values detected by the color dot sensing unit are (\hat{α}, \hat{β}, \hat{γ}). The relation between the CIE XYZ tristimulus values (X, Y, Z) and the RGB setting values (\hat{α}, \hat{β}, \hat{γ}) is expressed by Equation (1):

$$[ \begin{matrix}{A}_{11} & {A}_{12} & {A}_{13} \\ {A}_{21} & {A}_{22} & {A}_{23} \\ {A}_{31} & {A}_{32} & {A}_{33}\end{matrix} ] [ \begin{matrix}X \\ Y \\ Z\end{matrix} ] = [ \begin{matrix}\hat{α} \\ \hat{β} \\ \hat{γ}\end{matrix} ] \qquad ( 1 )$$

The square error between the real RGB setting values (α, α, γ) and the detected RGB setting values (\hat{α}, \hat{β}, \hat{γ}) is expressed by Equation (2):

$$δ = {\sum }_{n = 1}^{N} [ {( {\hat{α}}_{n} - {α}_{n} )}^{2} + {( {\hat{β}}_{n} - {β}_{n} )}^{2} + {( {\hat{γ}}_{n} - {γ}_{n} )}^{2} ] = {\sum }_{n = 1}^{N} [ \begin{matrix}{( {A}_{11} {X}_{n} + {A}_{12} {Y}_{n} + {A}_{13} {Z}_{n} - {α}_{n} )}^{2} + \\ {( {A}_{11} {X}_{n} + {A}_{12} {Y}_{n} + {A}_{13} {Z}_{n} - {β}_{n} )}^{2} + \\ {( {A}_{11} {X}_{n} + {A}_{12} {Y}_{n} + {A}_{13} {Z}_{n} - {γ}_{n} )}^{2}\end{matrix} ] \qquad ( 2 )$$

Suppose that the square error is the least. The least square error appears in the extremum points of the differentiated Equation (2) and can be expressed by Equations (3):

$${δ}_{min} ⇐ \frac{\partial δ}{\partial {A}_{11}} = \frac{\partial δ}{\partial {A}_{12}} = … = \frac{\partial δ}{\partial {A}_{33}} = 0 \qquad ( 3 )$$

The equations for the parameters (Equations (4)) of the transform matrix can be derived from Equation (3):

$$\{ \begin{matrix}\frac{\partial δ}{\partial {A}_{11}} = {\sum }_{n = 1}^{N} [ ( {A}_{11} {X}_{n} + {A}_{12} {Y}_{n} + {A}_{13} {Z}_{n} - {α}_{n} ) {x}_{n} ] = 0 ⇒ \\ ( {\sum }_{n = 1}^{N} {X}_{n}^{2} ) {A}_{11} + ( {\sum }_{n = 1}^{N} {X}_{n} {Y}_{n} ) {A}_{12} + ( {\sum }_{n = 1}^{N} {X}_{n} {Z}_{n} ) {A}_{13} = ( {\sum }_{n = 1}^{N} {α}_{n} {X}_{n} ) \\ \frac{\partial δ}{\partial {A}_{12}} = {\sum }_{n = 1}^{N} [ ( {A}_{11} {X}_{n} + {A}_{12} {Y}_{n} + {A}_{13} {Z}_{n} - {α}_{n} ) {y}_{n} ] = 0 ⇒ \\ ( {\sum }_{n = 1}^{N} {X}_{n} {Y}_{n} ) {A}_{11} + ( {\sum }_{n = 1}^{N} {Y}_{n}^{2} ) {A}_{12} + ( {\sum }_{n = 1}^{N} {Y}_{n} {Z}_{n} ) {A}_{13} = ( {\sum }_{n = 1}^{N} {α}_{n} {Y}_{n} ) \\ \frac{\partial δ}{\partial {A}_{13}} = {\sum }_{n = 1}^{N} [ ( {A}_{11} {X}_{n} + {A}_{12} {Y}_{n} + {A}_{13} {Z}_{n} - {α}_{n} ) {Z}_{n} ] = 0 ⇒ \\ ( {\sum }_{n = 1}^{N} {X}_{n} {Z}_{n} ) {A}_{11} + ( {\sum }_{n = 1}^{N} {Y}_{n} {Z}_{n} ) {A}_{12} + ( {\sum }_{n = 1}^{N} {Z}_{n}^{2} ) {A}_{13} = ( {\sum }_{n = 1}^{N} {α}_{n} {Z}_{n} ) \\ ⋮ ⋮ \\ \frac{\partial δ}{\partial {A}_{33}} = {\sum }_{n = 1}^{N} [ ( {A}_{31} {X}_{n} + {A}_{32} {Y}_{n} + {A}_{33} {Z}_{n} - {γ}_{n} ) {Z}_{n} ] = 0 ⇒ \\ ( {\sum }_{n = 1}^{N} {X}_{n} {Z}_{n} ) {A}_{31} + ( {\sum }_{n = 1}^{N} {Y}_{n} {Z}_{n} ) {A}_{32} + ( {\sum }_{n = 1}^{N} {Z}_{n}^{2} ) {A}_{33} = ( {\sum }_{n = 1}^{N} {γ}_{n} {Z}_{n} )\end{matrix} \qquad ( 4 )$$

Equations (4) can be expressed by Equations (5) in the form of matrices:

$$B [ \begin{matrix}{A}_{11} \\ {A}_{12} \\ {A}_{13}\end{matrix} ] = [ \begin{matrix}{\sum }_{n = 1}^{N} {α}_{n} {X}_{n} \\ {\sum }_{n = 1}^{N} {α}_{n} {Y}_{n} \\ {\sum }_{n = 1}^{N} {α}_{n} {Z}_{n}\end{matrix} ] , B [ \begin{matrix}{A}_{21} \\ {A}_{22} \\ {A}_{23}\end{matrix} ] = [ \begin{matrix}{\sum }_{n = 1}^{N} {β}_{n} {X}_{n} \\ {\sum }_{n = 1}^{N} {β}_{n} {Y}_{n} \\ {\sum }_{n = 1}^{N} {β}_{n} {Z}_{n}\end{matrix} ] , \\ B [ \begin{matrix}{A}_{31} \\ {A}_{32} \\ {A}_{33}\end{matrix} ] = [ \begin{matrix}{\sum }_{n = 1}^{N} {γ}_{n} {X}_{n} \\ {\sum }_{n = 1}^{N} {γ}_{n} {Y}_{n} \\ {\sum }_{n = 1}^{N} {γ}_{n} {Z}_{n}\end{matrix} ] \\ wherein \\ B = [ \begin{matrix}{\sum }_{n = 1}^{N} {X}_{n}^{2} & {\sum }_{n = 1}^{N} {X}_{n} {Y}_{n} & {\sum }_{n = 1}^{N} {X}_{n} {Z}_{n} \\ {\sum }_{n - 1}^{N} {X}_{n} {Y}_{n} & {\sum }_{n = 1}^{N} {Y}_{n}^{2} & {\sum }_{n - 1}^{N} {Y}_{n} {Z}_{n} \\ {\sum }_{n - 1}^{N} {X}_{n} {Z}_{n} & {\sum }_{n - 1}^{N} {Y}_{n} {Z}_{n} & {\sum }_{n - 1}^{N} {Z}_{n}^{2}\end{matrix} ] \qquad ( 5 )$$

B in Equation (5) can be further expressed by Equation (6):

$$B = {\sum }_{n = 1}^{N} [ \begin{matrix}{X}_{n}^{2} & {X}_{n} {Y}_{n} & {X}_{n} {L}_{n} \\ {X}_{n} {Y}_{n} & {Y}_{n}^{2} & {Y}_{n} {L}_{n} \\ {X}_{n} {L}_{n} & {Y}_{n} {L}_{n} & {L}_{n}^{2}\end{matrix} ] = {\sum }_{n = 1}^{N} ( [ \begin{matrix}{X}_{n} \\ {Y}_{n} \\ {L}_{n}\end{matrix} ] \cdot {[ \begin{matrix}{X}_{n} \\ {Y}_{n} \\ {L}_{n}\end{matrix} ]}^{T} ) \qquad ( 6 )$$

The parameters of the transform matrix can be obtained from the matrix operations shown in Equations (7) and (8):

$$\begin{matrix}[ \begin{matrix}{A}_{11} \\ {A}_{12} \\ {A}_{13}\end{matrix} ] = {B}^{- 1} [ \begin{matrix}{\sum }_{n = 1}^{N} {α}_{n} {X}_{n} \\ {\sum }_{n = 1}^{N} {α}_{n} {Y}_{n} \\ {\sum }_{n = 1}^{N} {α}_{n} {Z}_{n}\end{matrix} ] = {\sum }_{n = 1}^{N} {( [ \begin{matrix}{X}_{n} \\ {Y}_{n} \\ {Z}_{n}\end{matrix} ] \cdot {[ \begin{matrix}{X}_{n} \\ {Y}_{n} \\ {Z}_{n}\end{matrix} ]}^{T} )}^{- 1} \cdot [ \begin{matrix}{\sum }_{n = 1}^{N} {α}_{n} {X}_{n} \\ {\sum }_{n = 1}^{N} {α}_{n} {Y}_{n} \\ {\sum }_{n = 1}^{N} {α}_{n} {Z}_{n}\end{matrix} ] , \\ [ \begin{matrix}{A}_{21} \\ {A}_{22} \\ {A}_{23}\end{matrix} ] = {B}^{- 1} [ \begin{matrix}{\sum }_{n = 1}^{N} {β}_{n} {X}_{n} \\ {\sum }_{n = 1}^{N} {β}_{n} {Y}_{n} \\ {\sum }_{n = 1}^{N} {β}_{n} {Z}_{n}\end{matrix} ] , [ \begin{matrix}{A}_{31} \\ {A}_{32} \\ {A}_{33}\end{matrix} ] = {B}^{- 1} [ \begin{matrix}{\sum }_{n = 1}^{N} {γ}_{n} {X}_{n} \\ {\sum }_{n = 1}^{N} {γ}_{n} {Y}_{n} \\ {\sum }_{n = 1}^{N} {γ}_{n} {Z}_{n}\end{matrix} ] , & ( 7 ) \\ [ \begin{matrix}{A}_{11} & {A}_{12} & {A}_{13} \\ {A}_{21} & {A}_{22} & {A}_{23} \\ {A}_{31} & {A}_{32} & {A}_{33}\end{matrix} ] = {B}^{- 1} {\sum }_{n = 1}^{N} [ \begin{matrix}{α}_{n} {X}_{n} & {β}_{n} {X}_{n} & {γ}_{n} {X}_{n} \\ {α}_{n} {Y}_{n} & {β}_{n} {Y}_{n} & {γ}_{n} {Y}_{n} \\ {α}_{n} {Z}_{n} & {β}_{n} {Z}_{n} & {γ}_{n} {Z}_{n}\end{matrix} ] = {\sum }_{n = 1}^{N} {( [ \begin{matrix}{X}_{n} \\ {Y}_{n} \\ {Z}_{n}\end{matrix} ] \cdot {[ \begin{matrix}{X}_{n} \\ {Y}_{n} \\ {Z}_{n}\end{matrix} ]}^{T} )}^{- 1} \cdot {\sum }_{n = 1}^{N} [ \begin{matrix}{α}_{n} {X}_{n} & {β}_{n} {X}_{n} & {γ}_{n} {X}_{n} \\ {α}_{n} {Y}_{n} & {β}_{n} {Y}_{n} & {γ}_{n} {Y}_{n} \\ {α}_{n} {Z}_{n} & {β}_{n} {Z}_{n} & {γ}_{n} {Z}_{n}\end{matrix} ] & ( 8 )\end{matrix}$$

The parameters of a further higher order transform matrix can also be deduced by the same way. Suppose that the tristimulus values are expanded from three variables (X, Y, Z) to ten variables (1, X, Y, X, XY, XZ, YZ, X², Y², Z²), including a constant and several quadratic terms. The deductive process of from Equation (1) to Equation (8) can also apply to obtain the parameters of the transform matrix. The parameters for the transform matrix of the tristimulus values having mth-order terms (1, X, Y, Z, XY, XL, YZ, X², Y², Z², . . . Z^{m}) can also be obtained similarly and expressed by Equation (9):

$$[ \begin{matrix}{A}_{11} & {A}_{21} & {A}_{31} \\ {A}_{12} & {A}_{22} & {A}_{32} \\ {A}_{13} & {A}_{23} & {A}_{33} \\ ⋮ & ⋮ & ⋮ \\ {A}_{1 m} & {A}_{2 m} & {A}_{3 m}\end{matrix} ] = {\sum }_{n = 1}^{N} {( [ \begin{matrix}1 \\ {X}_{n} \\ {Y}_{n} \\ {Z}_{n} \\ {X}_{n} {Y}_{n} \\ {X}_{n} {Z}_{n} \\ {Y}_{n} {Z}_{n} \\ ⋮ \\ {Z}_{n}^{m}\end{matrix} ] \cdot {[ \begin{matrix}1 \\ {X}_{n} \\ {Y}_{n} \\ {Z}_{n} \\ {X}_{n} {Y}_{n} \\ {X}_{n} {Z}_{n} \\ {Y}_{n} {Z}_{n} \\ ⋮ \\ {Z}_{n}^{m}\end{matrix} ]}^{T} )}^{- 1} \cdot {\sum }_{n = 1}^{N} [ \begin{matrix}{α}_{n} & {β}_{n} & {γ}_{n} \\ {α}_{n} {X}_{n} & {β}_{n} {X}_{n} & {γ}_{n} {X}_{n} \\ {α}_{n} {Y}_{n} & {β}_{n} {Y}_{n} & {γ}_{n} {Y}_{n} \\ {α}_{n} {Z}_{n} & {β}_{n} {Z}_{n} & {γ}_{n} {Z}_{n} \\ ⋮ & ⋮ & ⋮ \\ {α}_{n} {Z}_{n}^{m} & {β}_{n} {Z}_{n}^{m} & {γ}_{n} {Z}_{n}^{m}\end{matrix} ] \qquad ( 9 )$$

In conclusion, the present invention proposes a chromatics-based reading/writing system, which is based on the principles of chromatics and stores/retrieves data in the form of color dots. Because of the very small dimensions of a dot, the storage medium according to the present invention can have a much higher capacity than an optical disc having the same area.

The embodiments described above are to enable the persons skilled in the art to understand, make and use the present invention. However, it is not intended to limit the scope of the present invention. Therefore, any equivalent modification or variation according to the spirit of the present invention is to be also included within the scope of the present invention.

What is claimed is:

1. A chromatics-based reading and writing system, comprising:
a color dot reading and writing device;
a color dot recording medium recording data in the color-dot form;
a computer system coupled to said color dot reading and writing device, coding at least one data into setting values of color dots, controlling said color dot reading and writing device to write said data on said color dot recording medium in the color-dot form according to said setting values of color dots, controlling said color dot reading and writing device to read color dots on said color dot recording medium, and decoding said setting values of said color dots into said data in an original form.

2. The chromatics-based reading and writing system according to claim 1, wherein said color dot reading and writing device further comprises:
a color output unit printing said color dots on said color dot recording medium according to said setting values of said color dots; and
a color dot sensing unit, detecting said color dots and generating a detection signal, and sending said detection signal to said computer system so that said computer system can decode said setting values of said color dots into said data in the original form.

3. The chromatics-based reading and writing system according to claim 2, wherein said color dot sensing unit is a spectrometer.

4. The chromatics-based reading and writing system according to claim 1, wherein said setting values of color dots are RGB setting values.

5. The chromatics-based reading and writing system according to claim 2, wherein said color output unit is an ink-jet printer or a laser printer.

6. A chromatics-based reading and writing method, comprising:
coding data into setting values of color dots;
writing data on a color dot recording medium in the color-dot form according to said setting values of color dots; and
reading color dots on said color dot recording medium, using a calculation process to transform said color dots into said setting values of said color dots, and decoding said setting values of said color dots into said data in the original form.

7. The chromatics-based reading and writing method according to claim 6, wherein said setting values of color dots are RGB setting values.

8. The chromatics-based reading and writing method according to claim 6, wherein the step of writing data on a color dot recording medium is a printing process.

9. The chromatics-based reading and writing method according to claim 6, wherein said calculation process includes: working out CIE XYZ tristimulus values (X, Y, Z), and using a transform matrix to transform said CIE XYZ tristimulus values into said setting values of said color dots.

10. The chromatics-based reading and writing method according to claim 9, wherein said CIE XYZ tristimulus values are worked out according to principles of chromatics.

11. The chromatics-based reading and writing method according to claim 9, wherein said transform matrix is a high order transform matrix.
